(19) United States
(12) Patent Application Publication
(10) Pub. No.: US 2010/0153197 A1
(43) Pub. Date: Jun. 17, 2010

(54) METHOD AND APPARATUS FOR PROVIDING ADVERTISING SERVICE

(76) Inventor: Gi-Man Byon, Seoul (KR)

Correspondence Address: LOWE HAUPTMAN HAM & BERNER, LLP, 1700 DIAGONAL ROAD, SUITE 300, ALEXANDRIA, VA, 22314, US

(21) Appl. No.: 12/303,810

(22) PCT Filed: Jun. 8, 2007
(86) PCT No.: PCT/KR07/02773

§ 371 Date: Dec. 8, 2008

(30) Foreign Application Priority Data
Jun. 8, 2006 (KR) 10 -2006-005514

(51) Int. Cl. G06Q 30/00; G06Q 10/00

(52) U.S. Cl. 705/14.14; 705/14.41; 705/14.52; 705/14.53; 705/14.55

(57) ABSTRACT

There is provided an advertising service providing method and apparatus capable of reducing a load of an advertising cost on an advertiser and increasing participation in an advertisement when providing advertising services via a wired or wireless communication network and a broadcasting network, the method including: collecting persons waiting for participating in an advertisement, determining a number of the persons, receiving a request of an advertiser for inserting an advertisement, determining a target number of advertisement participants and a target class with respect to the requested advertisement within a range of the persons, calculating an advertising cost and a total amount of winning/prize money in proportion to the determined target number of advertisement participants, providing the advertisement to the persons, the providing the advertisement is finished when a number of persons participating in the provided advertisement reaches the determined target number of advertisement participants, determining a prizewinner from the advertisement participants, and providing the determined total amount of winning/prize money to the prizewinner.

### TECHNICAL FIELD

The present invention relates to an advertising service providing method and apparatus using a communication network, the method and apparatus capable of increasing advertising effects while reducing advertising costs.

### BACKGROUND ART

Recently, as use of wired or wireless Internet has been rapidly increased, advertising methods in various forms, using the wired or wireless Internet, are provided.

Advertising methods using the wired or wireless Internet, conventionally provided, provide advertisements to more large number of users by increasing participation of communication users while full of information are provided using the wired or wireless Internet.

As most representative Internet advertising methods, there are banner advertisements. In this case, via a certain area of portal sites or homepages, that is, a banner inserted in an advertising area, a homepage of a company or products thereof are advertised. There is an effect of inducing an access to the homepage of the company or an advertising page by inserting a banner advertisement in a page where a lot of users access. However, recently, due to a jumble of banner advertisements, a click rate of a banner advertisement is gradually decreased. Accordingly, it is difficult to obtain a great advertising effect. Also, an advertising cost is determined according to a number of clicks of users, which is inefficient to calculate an advertising cost since the number of clicks is not surely proportional to the advertising effect, and which is provided to a plurality of unspecified persons in which an advertising object is not specified.

In another way, after inserting an advertisement with a prize or a total amount of winning/prize money in Internet, the prize or the total amount of winning/prize money is paid to a user chosen by a lot from users executing a task required in the advertisement, thereby causing an interest of users. In this case, users may show interest in the advertisement. However, as described above, since an advertising cost is calculated by a number of simple clicks, the advertising cost is too expensive in proportion to an advertising effect. In addition, since an advertiser has to additionally provide a prize or a total amount of winning/prize money to be used in an advertisement, a cost for a gift is added to the advertising cost, thereby increasing a load on the advertiser. In addition, since an advertising cost is calculated by a number of simple clicks for an advertisement by a plurality of unspecified persons, an advertiser is not capable of defining an advertising object or class.

In other ways, there are provided advertising methods using lotteries or electronic mails. However, since conventional methods are generally focused on a direction of increasing participation of users, a position of an advertiser is not considered. Accordingly, advertisers actually using advertisement turn away from the conventional methods.

### DISCLOSURE OF INVENTION

### Technical Problem

An aspect of the present invention provides an advertising service providing method and apparatus capable of reducing a load of an advertising cost on an advertiser and increasing participation in an advertisement when providing advertising services via a wired or wireless communication network and a broadcasting network.

An aspect of the present invention also provides an advertising service providing method and apparatus capable of inducing participation of advertisers by objectively determining an advertising cost proportional to an advertising effect in a view of advertisers.

An aspect of the present invention also provides an advertising service providing method and apparatus capable of obtaining a greater advertising effect by a lower advertising cost.

### Technical Solution

According to an aspect of the present invention, there is provided an advertising service providing method via a server providing advertising services, the method including: determining and providing a number of persons waiting for participating in an advertisement, the persons of a mind to execute a task associated with the advertisement, to an advertiser before providing the advertisement; receiving an advertisement request from the advertiser; determining a target number of persons participating in an advertisement requested by the advertiser, the target number desired by the advertiser, with the determined number of persons waiting for participating in the advertisement; calculating an advertising cost and a total amount of winning/prize money to be provided to an advertisement participant in proportion to the determined target number of persons participating in the advertisement; providing the advertisement of the advertiser and the task associated with the advertisement to the persons waiting for participating in the advertisement; receiving a result of executing the task associated with the advertisement from the persons waiting for participating in the advertisement; checking a number of persons executing the task associated with the advertisement and comparing the number with the determined target number of persons participating in the advertisement; and determining prizewinners among the persons executing the task associated with the advertisement according to a basis determined by one of an administrator and the advertiser and providing the determined winning/prize money to the prizewinners when a number of persons actually participating in the advertisement reaches the determined target number of persons participating in the advertisement and providing an amount of money less than the determined total amount of winning/prize money when the number of persons actually participating in the advertisement is less than the determined target number.

According to another aspect of the present invention, there is provided an advertising service providing method via a server providing advertising services, the method including: receiving an advertisement request from an advertiser; determining an advertising period of an advertisement requested by the advertiser; determining a target number of persons participating in the advertisement requested by the advertiser, the target number desired by the advertiser; calculating an advertising cost and a total amount of winning/prize money to be provided to an advertisement participant in proportion to the determined target number of persons participating in the advertisement; providing the advertisement of the advertiser and a task associated with the advertisement to a plurality of unspecified users; receiving a result of executing the task from an advertisement participant checking the provided advertisement and executing the task associated with the advertisement; checking and comparing a number of the advertisement participants executing the task associated with the advertisement with the determined target number of persons participating in the advertisement; checking whether the advertising period has passed; and determining prizewinners among the advertisement participants according to a basis determined by one of an administrator and the advertiser and providing the determined total amount of winning/prize money to the prizewinners when a number of persons actually participating in the advertisement reaches the determined target number of the advertisement participants before the advertising period has passed but providing an amount of money less than the determined winning/prize money depending on a ratio of a present number of the advertisement participants to the target number of the advertisement participants when the advertising period has passed.

According to still another aspect of the present invention, there is provided an advertising service providing apparatus including: an access unit processing a connection between an advertiser, a person waiting for participating in an advertisement, and an advertisement participant via a communication network and transmitting and receiving data therebetween; an advertisement participant management unit registering and administrating a communication user requesting an admission for a membership via the access unit, as the person waiting for participating in an advertisement; an advertisement control unit, when receiving an advertisement request from an advertiser via the access unit, receiving a target number of advertisement participants from the advertiser, determining an advertising cost and a total amount of winning/prize money in proportion to the target number of advertisement participants, checking whether a number of advertisement participants executing a task associated with the advertisement reaches the target number of advertisement participants of the advertisement, and controlling whether to insert the advertisement and winning/prize administration; an advertisement providing unit providing the advertisement requested by the advertiser and the task associated with the advertisement to the persons waiting for participating in an advertisement, according to a control of the advertisement control unit; a storage unit storing advertiser information, advertisement participant information, and advertisement information required in providing advertising services; and a prizewinner management unit selecting a prizewinner and allowing the determined total amount of winning/prize money to be paid according to a control of the advertisement control unit when a number of advertisement participants for each distributed advertisement reaches the target number of advertisement participants.

### Advantageous Effects

As described above, according to the present invention, an advertising cost is paid based on actual participation in an advertisement, thereby providing a more reasonable and effective advertising service than a conventional advertising method of paying an advertising cost in proportion to a number of simple clicks. In addition, an advertisement is performed using a paid advertising cost, thereby reducing an advertising cost. Also, a maximum advertising effect is obtained using a lower advertising cost in a view of advertisers, thereby increasing participation and interest of advertisers.

Also, a previously paid advertising cost is paid back to one selected according to a predetermined condition from advertisers, thereby maintaining participation and interest of advertisers.

### BRIEF DESCRIPTION OF THE DRAWINGS

FIG. 1 is a functional block diagram illustrating a schematic configuration of a system to which the present invention is applied;

FIG. 2 is a functional block diagram illustrating an advertising service providing server according to an exemplary embodiment of the present invention;

FIG. 3 is a diagram illustrating an example of an initial page provided by the advertising service providing server;

FIG. 4 is a diagram illustrating an example of an advertising page provided by the advertising service providing server;

FIG. 5 is a flowchart illustrating an advertising service providing method according to a first embodiment of the present invention;

FIG. 6 is a flowchart illustrating an advertising service providing method according to a second embodiment of the present invention;

FIG. 7 is a flowchart illustrating a variation of a process of determining a prizewinner in the advertising service providing method; and

FIG. 8 is a flowchart illustrating a process of paying an advertiser back in the advertising service providing method.

### BEST MODE FOR CARRYING OUT THE INVENTION

Hereinafter, an advertising service providing method according to an exemplary embodiment of the present invention will be described with reference to the attached drawings. In the following description, an administrator indicates a person providing an advertising service according to the present invention via a communication network, an advertiser indicates a person requesting the administrator an advertisement to advertise his or her product, persons waiting for participating in an advertisement indicate users notifying the administrator a mind of them to execute a task associated with an advertisement and waiting for executing the task, and advertisement participants indicate users actually executing the task provided with the advertisement from the persons waiting for participating in an advertisement.

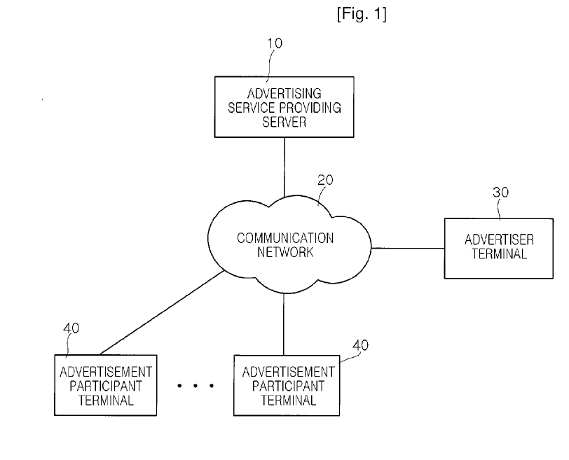

FIG. 1 is a functional block diagram illustrating a schematic configuration of a system to which the present invention is applied.

Referring to FIG. 1, an advertising service providing server 10 provides an advertising service employing an advertising service providing method according to an exemplary embodiment of the present invention, a communication network 20 connecting the server 10 to a plurality of advertisement participants and advertisers includes a wired network and a wireless network such as an Internet network and a mobile communication network. An advertiser terminal 30 allows an advertiser to access the server 10 via the communication network 20 and to receive the advertising service, and an advertisement participant terminal 40 indicates a terminal of an advertisement participant accessing the server via the communication network 20 and participating in an advertisement, which may be any terminal capable of accessing the server 10 via the communication network 20, such as a personal computer (PC), a personal digital assistant (PDA), and a mobile phone.

In the described configuration, the server 10 receives an advertisement insertion request of the advertiser from the advertiser terminal 30 via the communication network 20. In this case, the server 10 receives a desired advertisement range, in detail, a target number of advertisement participants and an advertising period from the advertiser and calculates an advertising cost in proportion to the received target number of advertisement participants. In this case, a virtual advertising cost generally applied is calculated by multiplying a generally predetermined advertisement unit price for one person by the received target number of advertisement participants, and the advertising cost is determined to be lower than the calculated virtual advertising cost. In addition, a total amount of winning/prize money to be provided to advertisement participants is determined to be within a range of the calculated advertising cost. The total amount of winning/prize money is set to be less than the calculated advertising cost.

As described above, the advertising service providing method according to an exemplary embodiment of the present invention determines the winning/prize money of the advertisement to be within the advertising cost paid by the advertiser, thereby reducing a load of an advertising cost since the advertiser is not required to pay the total amount of winning/prize money in addition to the advertising cost.

In addition, in the present invention, a total amount of winning/prize money of a plurality of advertisers is accumulated to be provided to the advertisement participants, thereby increasing winning/prize money and increasing participation of users. In this case, as a condition for winning a prize, advertisement participants have to execute a task associated with all advertisements provided by the plurality of advertisers, thereby providing reasonable advertising effects to all of advertisers.

When the advertising cost and the total amount of winning/prize money are determined as described above, the server 10 distributes advertising data together with prize information to advertisement participant terminals 41 to 43 via the communication network 20. In this case, the advertisement participant may be a communication network user of a mind to participate in an advertisement provided by the server 10 and accessing the server 10 to join as a member. When receiving basic information of the advertisement participant, such as age, sex, an area, and an hobby, in a process of joining as a member, objects of advertisement participants to which advertisements are distributed in the future may be more effectively selected. In this case, persons waiting for participating in an advertisement are divided into a plurality of classes by using the information and provided to the advertiser, thereby enabling the advertiser to select a target class to which the advertisement is provided.

In addition, the advertisement may be provided in various ways, via Internet, a mobile communication network, and a broadcasting network. For example, the advertisement may be provided by inserting in a portal site, be directly delivered to advertisement participants via an electronic mail, and be provided via a webpage constructed by the server 10. Also, the advertisement may be provided on TV, via one of terrestrial broadcasting and cable broadcasting.

Corresponding advertisement participants join an advertisement distributed as described above and execute a task presented by the corresponding advertisement, such as a game and a quiz. A result of executing the task is collected and aggregated by the server 10. The server 10 determines a prizewinner from the advertisement participants by one of lot, order of application, and determining a rank, based on aggregated information and pays the determined total amount of winning/prize money to the prizewinner. In this case, when the number of actual advertisement participants reaches the determined target number of advertisement participants, the total amount of winning/prize money is paid. When the number of actual advertisement participants is below the target number, the determined total amount of winning/prize money is lowered or providing the total amount of winning/prize money is delayed or carried forward, thereby preventing the advertiser from unnecessarily expending an advertising cost.

Also, the advertisement participants are grouped and a winning probability is determined to be different depending on participation for each group, thereby increasing an advertisement participation rate.

In addition, the server 10 determines a prizewinner from advertisers by one of lot and an advertisement and pays the determined advertiser back a certain rate of a total amount of advertising costs paid by all advertisers, thereby increasing participation of advertisers and reducing an expense load.

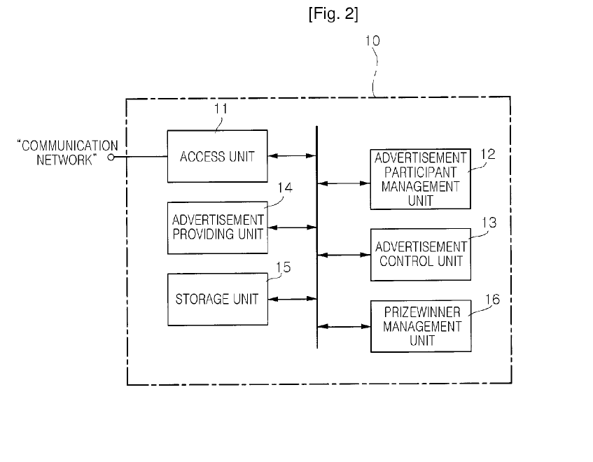

FIG. 2 is a functional block diagram illustrating the server 10 according to an exemplary embodiment of the present invention. Referring to FIG. 2, the server 10 includes an access unit 11, an advertisement participant management unit 12, an advertisement control unit 13, an advertisement providing unit 14, a storage unit 15, and a prizewinner management unit 16.

The access unit 11 processes an access of one of the advertiser and an advertisement participant via the communication network 20 and may perform authentications on the advertiser and advertisement participant via a login process. The access unit 11 provides an initial webpage for providing an advertising service to a user accessing the server 10 and processes an admission for membership and a login of a member via the initial webpage.

The advertisement participant management unit 12 registers communication users, the admitted members via the access unit 11 as persons waiting for participating in an advertisement, divides and manages the persons waiting for participating in an advertisement according to various bases such as an area, age, and sex, and manages advertisement participation information for each of the persons waiting for participating in an advertisement.

The advertisement control unit 13 receives an advertisement request from an advertiser accessing the server 10, receives and manages an advertising range desired by the corresponding advertiser, such as a target number of advertisement participants and/or an advertising period, checks whether the target number of advertisement participants with respect to an inserted advertisement is reached and whether the advertising period has passed, and control whether to finish providing the advertisement and a winning/prize process.

The advertisement providing unit 14 distributes an advertisement registered in the advertisement control unit 13 via the communication network 20. In this case, according to a control of the advertisement control unit 13, when the target number of advertisement participants is reached or the determined advertising period has passed, the providing the advertisement is finished. In addition, the advertisement providing unit 14 determines a category of the distributed advertisement and inserts the advertisement in the website provided by the server 10, thereby enabling the advertisement to be searched to be shown to users accessing the website.

The storage unit 15 stores advertiser information, advertisement participant information, and advertisement information required to provide an advertising service in the server 10.

The prizewinner management unit 16, according to a control of the advertisement control unit 13, determines prizewinners based on a total amount of winning/prize money calculated from an advertising cost initially set by the advertiser when the number of advertisement participants for each of the distributed advertisements reaches the target number of advertisement participants. When the target number of advertisement participants is not reached and the set advertising period has passed, the prizewinner management unit 16 determines and pays the prizewinners a total amount of winning/prize money reduced in proportion to a ratio of the target number of advertisement participants to the number of actual advertisement participants. Also, according to the control of the advertisement control unit 13, the prizewinner management unit 16 determines a prizewinner by selecting an advertiser corresponding to a preset condition from advertisers requesting an advertisement and pays back the selected advertiser a set expense. In this case, an amount of money to be paid back is a certain portion of a total amount of advertising costs obtained by adding advertising costs of the advertisers those are objects of a prize.

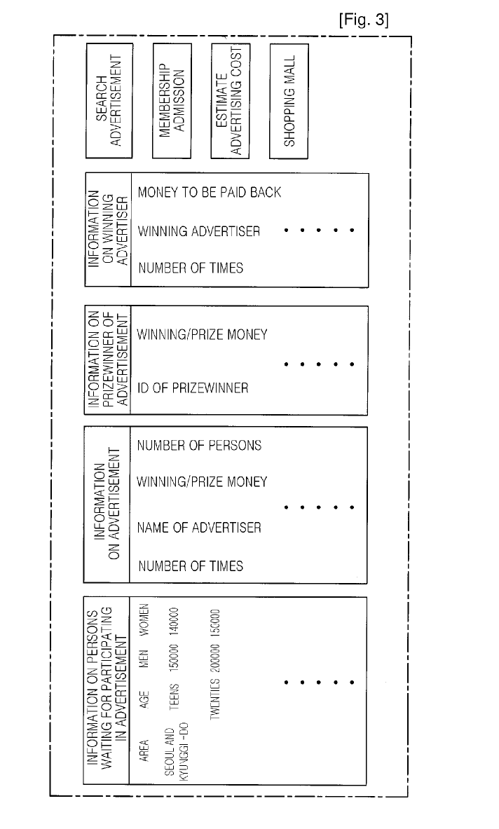

FIG. 3 is a diagram illustrating an example of the initial page provided by the server 10.

Referring to FIG. 3, the server 10 divides the number of the persons waiting for participating in an advertisement, the persons admitted as members, according to a region, sex, and age to be provided via a section for information on the persons waiting for participating in an advertisement. This allows an advertiser having a possibility of requesting an advertisement and an advertiser requesting an advertisement to check distribution of advertising objects to which an advertisement thereof is provided, which may increase reliability of the advertisers.

Also, the server 10 collects advertisers inserting an advertisement for each time and provides information of collected advertisements for each time. In this case, in the information of the advertisement includes advertiser information, a total amount of winning/prize money, and the number of participants. The advertisement participants may search a desired advertisement via the information and compare the total amount of winning/prize money and a winning/prize probability thereof with one another.

Also, the server 10 may increase reliability of the advertisers with respect to a result of executing an advertisement and increase a will of the advertisement participants for participation by inserting the prizewinner information determined for each previously inserted advertisement via a section for information on prizewinners.

Also, the server 10 pays the persons waiting for participating in an advertisement the total amount of winning/prize money, thereby increasing a will of the advertisement participants for participation. In addition, an advertiser requesting an advertisement is selected for each time and an advertising cost is paid back to the selected advertiser, thereby increasing interest of advertisers to cause continuous participation.

In addition, the server 10 further provides an advertisement search function to easily search a desired advertisement, a member admission function for advertisers participating in the advertisement service and the advertisement participants, a function for estimating an advertising cost for an advertisement desired by the advertiser via an advertising service page. Also, a function of linking to a shopping mall selling products corresponding to an inserted advertisement is added, thereby connecting advertisement participation to purchase.

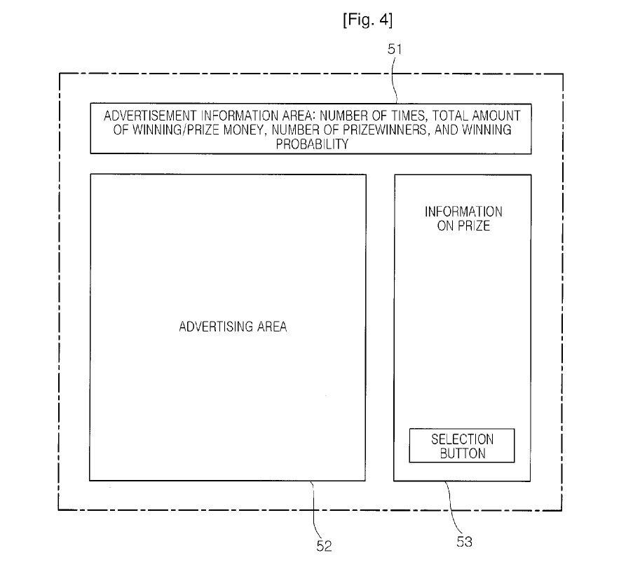

FIG. 4 is a diagram illustrating an example of an advertising page provided in the advertising service page when a person waiting for participating in an advertisement selects a predetermined advertisement.

Referring to FIG. 4, the advertising page includes an advertising information area 51 displaying information on an advertisement, such as the number of times, a total amount of winning/prize money, the number of prizewinners, and a winning probability, an advertising area 52 displaying contents of an advertisement requested by an advertiser, and a prize information section 53 displaying information on an object of the advertisement inserted in the advertising area 52 together with a task in the form of a quiz. In the prize information section 53, information on the task to be executed by the advertisement participants and a selection button for carrying a will of participation are included. In this case, the task provided via the prize information section 53 is associated with the advertisement inserted in the advertising area 52, thereby increasing an advertising effect. After checking the advertising information area 51, the advertising area 52, and the prize information area 53, the advertisement participants click the selection button and execute a corresponding task, thereby participating in the advertisement. Information on the advertisement participants participating as described above is collected and aggregated by the advertisement participant management unit 12, and the advertisement participants become objects of winning/prize of the prizewinner management unit 16.

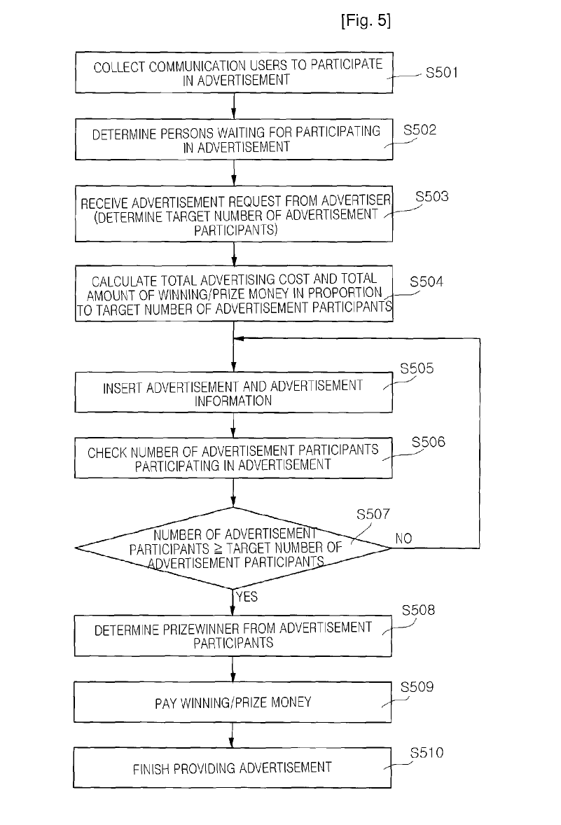

Hereinafter, with reference to FIGS. 5 through 8, the advertising service providing method provided via the server 10 will be described according to sequence thereof.

FIG. 5 is a flowchart illustrating an advertising service providing method according to a first embodiment of the present invention.

Referring to FIG. 5, before performing an advertisement service, the server 10 collects communication users of a mind to execute a task associated with the advertisement and determines persons waiting for participating in the advertisement (S501 and S502). The processes may be performed by inducing Internet users to be advertisement participants of the advertising service by providing the advertisement and advertisement participation information via portal sites, cafes, blogs, and minihompies, where a plurality of persons accesses. The number of the persons waiting for participating in the advertisement collected as described above is provided to advertisers via the advertising service page as shown in FIG. 3, thereby increasing reliability of the advertiser with respect to an administrator.

Also, the server 10 receives an advertisement request from the advertiser via the advertiser terminal 30. In this case, a desired advertising range such as a target number of advertisement participants determined by the advertiser from the advertiser (S503). In addition, in the operation S503, an object to which an advertisement is provided, that is, a target class may be further selected. The target class indicates at least one group of groups obtained by dividing the persons waiting for participating in the advertisement according to bases such as an area, age, and sex.

An advertising cost and a total amount of winning/prize money are calculated in proportion to the determined target number of advertisement participants. In this case, an advertising cost is calculated base on a general advertisement unit price, a real advertising cost is determined to be lower than the calculated advertising cost, and a total amount of winning/prize money used for the advertisement is determined to be a certain rate of the calculated advertising cost (S504). In this case, a ratio of the total amount of winning/prize money to the advertising cost may be determined to be uniform.

As described above, when the advertising cost and the total amount of winning/prize money are calculated, the advertisement requested by the advertiser is provided to the persons waiting for participating in the advertisement (S505). In this case, when the target class is determined, the advertisement may be selectively provided to persons included in the corresponding target class. On the other hand, after providing to a plurality of unspecified persons, it is possible to allow users admitted as a member and corresponding to a condition to execute a task.

In this case, as described above, the advertisement may be provided by transmitting electronic mails and inserting in portal sites and websites via Internet, a mobile communication network, and a broadcasting network. As shown in FIG. 4, advertisement information and a task to be executed by the advertisement participants together with basic information of the advertisement are presented, and a result of executing the task is transmitted to the server 10. In addition, the provided advertisements are accumulated and managed in such a way that previously provided advertisements are capable of being searched via a homepage provided by the server 10. In this case, when the advertisement is received via an electronic mail but the mail is lost before participating in the advertisement, the user may participate in the advertisement by additionally searching the homepage or may search the previously provided advertisements.

The server 10 checks the number of advertisement participants participating in the provided advertisement (S506) and determines whether a total number of advertisement participants reaches the previously determined target number of advertisement participants (S507).

When the target number of advertisement participants is not reached, providing the advertisement is maintained to induce participation of other persons waiting for participating in the advertisement.

On the other hand, as a result of the checking, when the target number of advertisement participants is reached, a prizewinner is determined from the advertisement participants according to one of a condition and a way previously determined by one of an administrator and the advertiser (S508), pays the determined prizewinner the previously determined total amount of winning/prize money, and inserts winning/prize information via the advertising service page (S509). In this case, when the target number of advertisement participants is reached, the providing the corresponding advertisement is finished (S510).

The present embodiment corresponds to an undetermined period type, advertising effects may be determined by checking the number of advertisement participants. The advertisement is continuously provided until an advertising effect corresponding to an advertising cost paid by the advertiser appears, thereby increasing reliability of the advertiser and preventing departure of the advertiser due to an inaccurate advertising effect and an irreasonable advertising cost calculation.

In addition, in the present invention, a plurality of advertisers participating in advertising services is collected for each predetermined period, and operations shown in FIG. 5 are performed with respect to the collected advertisers. In this case, the total amount of winning/prize money of a corresponding time is determined as a value obtained by accumulating the total amount of winning/prize calculated for each of the collected advertisers, and the total amount of winning/prize money of the corresponding time is provided to an advertisement participant executing a task associated with advertisements of the corresponding time by a winning/prize process. In this case, a participation rate of the advertisement participants may be more increased by increasing the total amount of winning/prize money provided to the advertisement participant.

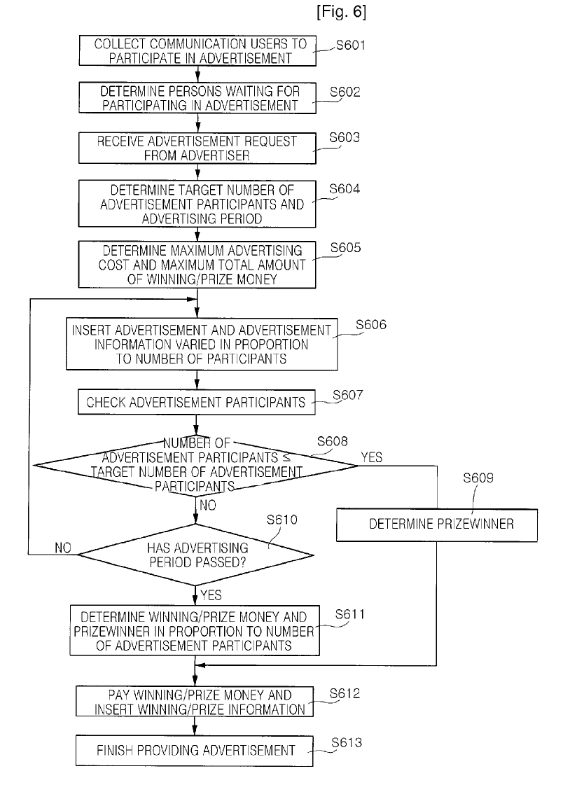

FIG. 6 is a flowchart illustrating an advertising service providing method according to a second embodiment of the present invention.

Referring to FIG. 6, before providing an advertisement, the number of persons waiting for participating in an advertisement, the persons showing their minds to execute a task associated with the advertisement to one of the server 10 and the administrator is determined (S601 and S602). The processes may be performed by inducing Internet users to be advertisement participants of the advertising service by providing the advertisement and advertisement participation information via portal sites, cafes, blogs, and minihompies, where a plurality of persons accesses. The persons waiting for participating in the advertisement determined here are provided to advertisers via the advertising service page as shown in FIG. 3, thereby increasing reliability of the advertiser with respect to the administrator.

Also, the server 10 receives an advertisement request from the advertiser via the advertiser terminal 30 (S603). In this case, a desired advertising region, such as a target number of advertisement participants, and an advertising period are determined by the advertiser (S604). Also, similar to the previous embodiment, a target class of the advertisement may be further set.

In proportion to the determined target number of advertisement participants, a maximum advertising cost and a maximum total amount of winning/prize money are calculated (S605). In this case, an advertising cost is calculated base on a general advertisement unit price, a real advertising cost is determined to be lower than the calculated advertising cost, and a total amount of winning/prize money used for the advertisement is determined to be a certain rate of the calculated advertising cost. In this case, a ratio of the total amount of winning/prize money to the advertising cost may be determined to be uniform.

As described above, when the advertising cost and the total amount of winning/prize money are calculated, the advertisement requested by the advertiser is provided to objects of the advertisement via the communication network 20 (S606). In this case, a method of providing the advertisement is identical to the previous embodiment. The advertisement provided to the objects of the advertisement is inserted in a homepage provided by the server 10 to be searched at anytime by the objects of the advertisement.

The persons waiting for participating in the advertisement, who receives the advertisement, execute a corresponding task, and a result of executing the task is transmitted to the server 10.

Then, the server 10 checks the number of advertisement participants participating in the provided advertisement (S607), determines whether a total number of advertisement participants reaches the determined target number of advertisement participants (S608), and determines whether the determined advertising period has passed (S610). As a result of the determining, when the target number of advertisement participants is not reached and the determined advertising period does not pass, providing the corresponding advertisement is maintained to induce participation of other persons waiting for participating in the advertisement.

On the other hand, when the target number of advertisement participants is reached before the advertising period passes, a prizewinner is selected from the advertisement participants checked to participate in the advertisement (S609), the preset maximum total amount of winning/prize money is paid to the determined prizewinner and winning/prize information is inserted via an advertising service page (S612).

On the other hand, when the target number of advertisement participants is not reached but the advertising period has passed, an amount of winning/prize money is set from a target amount of winning/prize money by a ratio of advertisement participants for now to the target number of advertisement participants and a prizewinner is determined (S611). When the total amount of winning/prize money is paid to the determined prizewinner, winning/prize information is inserted in the advertising service page (S612).

In the described process, when the target number of advertisement participants is reached or the advertising period has passed, the providing the corresponding advertisement is finished (S613). The described embodiment corresponds to a determined period type, in which the advertisement is provided only within a determined period, an advertising effect in the determined period is checked based on the number of advertisement participants, and an advertising cost and a total amount of winning/prize money are varied with a rate of the advertisement participants.

As described above, in the present invention, an advertising period is determined and an advertising cost is undetermined in such a way that an advertising cost is paid proportional to an advertising effect shown in the determined advertising period, thereby enabling an advertiser to pay a reasonable advertising cost and inducing participation of advertisers.

In addition, similar to the described above, a plurality of advertisers participating in advertising services is collected for each predetermined period, and operations shown in FIG. 6 are performed with respect to the collected advertisers. In this case, the total amount of winning/prize money of a corresponding time is determined as a value obtained by accumulating the total amount of winning/prize calculated for each of the collected advertisers, and the total amount of winning/prize money of the corresponding time is provided to an advertisement participant executing a task associated with advertisements of the corresponding time by a winning/prize process. In this case, a participation rate of the advertisement participants may be more increased by increasing the total amount of winning/prize money provided to the advertisement participant.

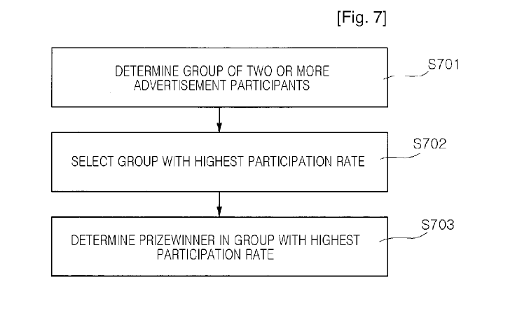

As shown in FIG. 7, to increase the participation rate, advertisement participants may be grouped together with a desired person to form a predetermined group (S701), a participation rate is checked for each the determined group, a group with a highest participation rate is selected (S702), and a prizewinner may be selected in a corresponding group or the prizewinner may be determined by increasing a winning probability of the corresponding group (S703). In this case, an advertisement participation rate may be increased via a competition between groups.

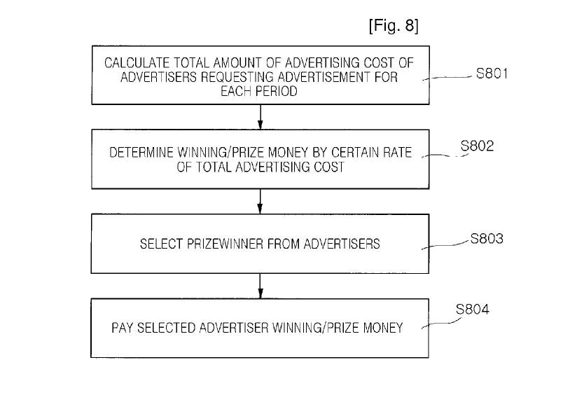

As shown in FIG. 8, in addition to paying a total amount of winning/prize money to advertisement participants, a total advertising cost paid by advertisers requesting an advertisement is calculated for each period (S801), a certain rate of the calculated total advertising cost is determined to be money to be paid back (S802), a prizewinner is selected from the advertisers requesting an advertisement in a corresponding period (S803), and the determined total amount of winning/prize money is paid to the prizewinner (S804). According to the described above, a prizewinner is selected from advertisers paying an advertising cost and the determined amount of money is paid back to the prizewinner, thereby providing an effect of reducing a load of an advertising cost on an advertiser and inducing a continuous advertisement request of advertisers.

In addition, the advertising service providing method according to an exemplary embodiment of the present invention may accumulate and transfer the total amount of determined winning/prize money to an advertisement of another advertiser.

### INDUSTRIAL APPLICABILITY

As described above, according to the present invention, an advertising cost is paid based on actual participation in an advertisement, thereby providing a more reasonable and effective advertising service than a conventional advertising method of paying an advertising cost in proportion to a number of simple clicks. In addition, an advertisement is performed using a paid advertising cost, thereby reducing an advertising cost. Also, a maximum advertising effect is obtained using a lower advertising cost in a view of advertisers, thereby increasing participation and interest of advertisers.

Also, a previously paid advertising cost is paid back to one selected according to a predetermined condition from advertisers, thereby maintaining participation and interest of advertisers.

1. An advertising service providing method via a server providing advertising services, the method comprising:
determining and providing a number of persons waiting for participating in an advertisement, the persons of a mind to execute a task associated with the advertisement, to an advertiser before providing the advertisement;
receiving an advertisement request from the advertiser;
determining a target number of persons participating in an advertisement requested by the advertiser, the target number desired by the advertiser, with the determined number of persons waiting for participating in the advertisement;
calculating an advertising cost and a total amount of winning/prize money to be provided to an advertisement participant in proportion to the determined target number of persons participating in the advertisement;
providing the advertisement of the advertiser and the task associated with the advertisement to the persons waiting for participating in the advertisement;
receiving a result of executing the task associated with the advertisement from the persons waiting for participating in the advertisement;
checking a number of persons executing the task associated with the advertisement and comparing the number with the determined target number of persons participating in the advertisement; and
determining prizewinners among the persons executing the task associated with the advertisement according to a basis determined by one of an administrator and the advertiser and providing the determined winning/prize money to the prizewinners when a number of persons actually participating in the advertisement reaches the determined target number of persons participating in the advertisement and providing an amount of money less than the determined total amount of winning/prize money when the number of persons actually participating in the advertisement is less than the determined target number.

2. The method of claim 1, wherein, in the determining and providing a number of persons waiting for participating in an advertisement, a target group to which the advertisement is provided is further determined among a plurality of groups obtained by dividing the determined persons waiting for participating in the advertisement according to a basis, and the advertisement is provided to the persons waiting for participating in the advertisement and included in the determined target group.

3. The method of claim 1, further comprising:
determining an advertising period of the advertisement;
checking whether the determined advertising period has passed, after providing the advertisement; and
determining prizewinners and providing an amount of money less than the determined total amount of winning/prize money when the advertising period has passed and the checked number of persons actually participating in the advertisement does not reach the determined target number of persons participating in the advertisement.

4. The method of claim 1, wherein, the advertisement is provided until the checked number reaches the target number, and the providing the advertisement is finished when the checked number of persons actually participating in the advertisement reaches the determined target number of persons participating in the advertisement.

5. The method of claim 1, further comprising providing a function of searching advertisements currently provided, to the persons waiting for participating in the advertisement and providing information of an advertisement meeting a designated condition when the persons waiting for participating in the advertisement selects the search function.

6. The method of claim 1, wherein two or more of the persons waiting for participating in the advertisement are set to form a group, and a winning probability of the prizewinners is determined to be different depending on how many times each of the determined groups participates in the advertisement.

7. An advertising service providing method via a server providing advertising services, the method comprising:
receiving an advertisement request from an advertiser;
determining an advertising period of an advertisement requested by the advertiser;
determining a target number of persons participating in the advertisement requested by the advertiser, the target number desired by the advertiser;
calculating an advertising cost and a total amount of winning/prize money to be provided to an advertisement participant in proportion to the determined target number of persons participating in the advertisement;
providing the advertisement of the advertiser and a task associated with the advertisement to a plurality of unspecified users;
receiving a result of executing the task from an advertisement participant checking the provided advertisement and executing the task associated with the advertisement;
checking and comparing a number of the advertisement participants executing the task associated with the advertisement with the determined target number of persons participating in the advertisement;
checking whether the advertising period has passed; and determining prizewinners among the advertisement participants according to a basis determined by one of an administrator and the advertiser and providing the determined total amount of winning/prize money to the prizewinners when a number of persons actually participating in the advertisement reaches the determined target number of the advertisement participants before the advertising period has passed but providing an amount of money less than the determined winning/prize money depending on a ratio of a present number of the advertisement participants to the target number of the advertisement participants when the advertising period has passed.

8. The method of claim 7, wherein the calculating an advertising cost and a total amount of winning/prize money comprises:
calculating a virtual total amount by multiplying the determined target number of the advertisement participants by a previously calculated advertisement unit price for one person;
calculating the advertising cost to be less than the calculated virtual total amount; and
calculating the total amount of winning/prize money to be less than the calculated advertising cost.

9. The method of claim 7, wherein the calculated advertising cost comprises the calculated total amount of winning/prize money.

10-11. (canceled)

12. The method of claim 7, wherein the providing the advertisement is finished when the checked number of the advertisement participants reaches the target number of the advertisement participants or the determined advertising period has passed.

13. The method of claim 7, wherein, according to the described process, the calculated total amount of winning/prize money with respect to advertisements of a plurality of advertisers requesting for an advertisement is accumulated in a predetermined period, and the accumulated total amount of winning/prize money is provided to an advertisement participant winning a prize, according to a preset condition.

14-22. (canceled)

23. An advertising service providing method comprising:
determining a number of advertisement participants by an advertiser requesting an advertisement;
calculating a virtual total amount by multiplying the determined target number of advertisement participants by a advertisement unit price for one person;
determining an advertising cost to be less than the calculated virtual total amount and calculating a winning/prize money to be provided to an advertisement participants executing a task associated with the advertisement within a range of the determined advertising cost or less; providing the advertisement and the task associated with the advertisement to a plurality of unspecified persons;
receiving a result of executing the task from an advertisement participants executing the task associated with the provided advertisement;
checking whether a number of the advertisement participants executing the task reaches the determined target number of advertisement participants; and
determining prizewinners from the advertisement participants executing the task according to a basis determined by one of an administrator and the advertiser and providing the determined total amount of winning/prize money to the prizewinners when a number of the advertisement participants executing the task reaches the determined target number of the advertisement participants as a result of the checking.

24. The method of claim 23, wherein the advertisement is provided to a communication and broadcasting device of the persons waiting for participating in an advertisement, the device comprising a personal computer, a mobile terminal, and a television, via one of Internet, a mobile communication network, and a broadcasting network.

25. (canceled)

26. The method of claim 23, wherein the advertisement is provided in an advertisement period determined before providing the advertisement, and providing the advertisement with the determined advertisement period is finished when the determined advertisement period has passed after providing the advertisement, regardless of whether the target number of advertisement participants is reached.

27-31. (canceled)

32. A method for providing an advertising service by operating a server interacting with terminals of many persons to provide advertisement contents to each of the terminals of the persons, the method comprising the steps of;
communicating an information between the server and an advertiser to determine a target number of participants in advertisement with respect to a number of persons that are expected to watch the advertisement contents to be advertised;
providing the advertisement contents and a task associated with the advertisement contents to the terminals of the persons, the advertisement contents being what the advertiser wants to advertise;
receiving results of execution of the task associated with the advertisement contents from the terminals of the persons for comparing the target number of the participants in advertisement with a number of persons having executed the task; and
after the comparing, determining prizewinners among the persons having executed the task associated with the advertisement contents when a number of persons actually participated in the advertisement reaches the target number of the participants in advertisement.

33. The method of claim 32, further comprising the step of sending and receiving between the server and the advertiser an information for calculating an advertising cost in proportion to the target number of participants in advertisement.

34. The method of claim 32, wherein the persons are waiting persons for participation in the advertisement contents who have intentions to watch the advertisement contents provided from the server.

35. The method of claim 32, wherein the persons are classified in groups of a region, an age or a sex, and the step of communicating the information between the server and the advertiser further comprises the step of allowing the advertiser to select at least one of the groups.

36. The method of claim 34, wherein the waiting persons for participation in the advertisement contents are classified in groups of a region, an age or a sex, and the step of communicating the information between the server and advertiser further comprises the step of allowing the advertiser to select at least one of the groups.

37. The method of claim 33, wherein a winning money provided to the prizewinners is estimated within the advertising const.

38. The method of claim 32, further comprising the step of providing a winning money to prizewinners determined among the persons having executed the task out of the number of persons actually participated in the advertisement in consideration of the number of persons actually participated in the advertisement when, after the comparing, the number of persons actually participated in the advertisement does not even reach the target number of participants in advertisement.

39. The method of claim 32, further comprising the step of checking whether an advertising period for providing the advertisement contents for a predetermined period has lapsed, and further comprising the step of providing a winning money to prizewinners determined among the persons having executed the task out of the number of persons actually participated in the advertisement when, after the comparing, the advertising period has lapsed though the number of persons actually participated in the advertisement does not reach the target number of participants in advertisement.

40. The method of claim 32, wherein the step of providing the task associated with the advertisement contents further comprises the step of enabling the persons to search other advertisements being provided on the server.

41. A method for providing an advertising service comprising the steps of:
determining an order of an advertising round, the advertising round being provided with at least two separate advertisements and performing the steps as defined in claim 32; and
cumulatively calculating a winning money fixed in each of the separate advertisements of the advertising round for providing the winning money to the prizewinners.

42. The method of claim 41, further comprising the step of sending and receiving between the server and the advertiser an information for calculating an advertising cost in proportion to the target number of participants in advertisement.

43. The method of claim 33, wherein the persons are waiting persons for participation in the advertisement contents who have intentions to watch the advertisement contents provided from the server.

44. The method of claim 33, wherein the persons are classified in groups of a region, an age or a sex, and the step of communicating the information between the server and the advertiser further comprises the step of allowing the advertiser to select at least one of the groups.

45. The method of claim 33, further comprising the step of providing a winning money to prizewinners determined among the persons having executed the task out of the number of persons actually participated in the advertisement in consideration of the number of persons actually participated in the advertisement when, after the comparing, the number of persons actually participated in the advertisement does not even reach the target number of participants in advertisement.

46. The method of claim 33, further comprising the step of checking whether an advertising period for providing the advertisement contents for a predetermined period has lapsed, and further comprising the step of providing a winning money to prizewinners determined among the persons having executed the task out of the number of persons actually participated in the advertisement when, after the comparing, the advertising period has lapsed though the number of persons actually participated in the advertisement does not reach the target number of participants in advertisement.

47. The method of claim 33, wherein the step of providing the task associated with the advertisement contents further comprises the step of enabling the persons to search other advertisements being provided on the server.
